(19) United States
(12) Patent Application Publication
(10) Pub. No.: US 2012/0251897 A1
(43) Pub. Date: Oct. 4, 2012

(54) Aluminum Air Battery Including a Composite Anode

(75) Inventors: Thomas A. Yager, Encinitas, CA (US); Ezekiel Kruglick, Poway, CA (US)

(73) Assignee: EMPIRE TECHNOLOGY DEVELOPMENT LLC, Wilmington, DE (US)

(21) Appl. No.: 13/056,476

(22) PCT Filed: Sep. 30, 2010
(86) PCT No.: PCT/US10/50954

§ 371 Date: Jan. 28, 2011

(51) Int. Cl. H01M 8/22; B05D 5/12

(52) U.S. Cl. 429/406; 427/115

(57) ABSTRACT

A method to produce an aluminium air battery, comprising: forming a selectively reactive coating on a surface of an anode core to form a composite anode, the selectively reactive coating comprising a zinc alloy and the anode core comprising aluminium; and storing an electrolyte in contact with the composite anode, wherein the selectively reactive coating is capable of chemically reacting with the electrolyte during discharging of the aluminium air battery the reactive coating may also include an anode corrosion inhibitor material consisting of one or more of indium, gallium, lead, thallium or mercury

### BACKGROUND

Aluminum has been a sought after source of energy because of high energy density properties, lightweight properties, and recyclable properties. Initial attempts at aluminum air batteries, unfortunately, had substantial corrosion issues. Other attempts at aluminum air batteries led to the use of aluminum alloys including additives such as tin, indium, thallium, iridium or gallium to lower such corrosion. However, such additives may increase the internal resistance of the battery by causing the electrolyte to gel during use, may increase cost, and may hamper recycling of byproducts. Current aluminum air batteries may be used as batteries in critical backup system (i.e., in telephone exchanges), but the liquid electrolyte may be stored separately in order to avoid corrosion. Often this means that such critical backup systems may be failure-dependent on a storage and/or pumping module to fill the battery when needed.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

This disclosure is drawn, inter alia, to methods, apparatus, and systems related to aluminum air batteries including a composite anode.

Some example methods related to aluminum air batteries may include forming a selectively reactive coating on a surface of an anode core, and storing an electrolyte in contact with the composite anode. The selectively reactive coating may include a zinc alloy, and the anode core may include aluminum. The selectively reactive coating may be capable of chemically reacting with the electrolyte during discharging of the aluminum air battery.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is an illustration of an example process to produce an aluminum air battery;

FIG. 2 illustrates another example process to produce an aluminum air battery;

FIG. 3 is an illustration of an example cross-sectional side view of a portion of a composite anode at a given stage of processing;

FIG. 4 is an illustration of an example cross-sectional side view of a portion of a composite anode at a given stage of processing;

FIG. 5 is an illustration of an example cross-sectional side view of a portion of a composite anode at a given stage of processing;

FIG. 6 is an illustration of an example cross-sectional side view of a portion of a composite anode at a given stage of processing;

FIG. 7 is an illustration of an example battery; and

FIG. 8 is an illustration of another example battery, all arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to aluminum air batteries including a composite anode.

Aluminum air batteries have one of the highest power densities of all batteries, approximately twice that of a comparable zinc air battery, and can approach the energy density of gasoline. However, aluminum air batteries may have anode corrosion during storage if the anode is in contact with electrolyte. To deal with this limitation, the anodes may be kept separate from the electrolyte during inactive storage periods. Aluminum air batteries for emergency lights, for example, may keep the electrolyte in a separate tank and release it into the battery when operation is needed. Other types of aluminum air batteries (i.e., those used for automotive applications) may have pump systems capable of controlling the flow of the electrolyte to the anode. This pumping system may increase the complexity of the battery and may reduce the energy density of the battery.

As will be discussed in greater detail below, aluminum air batteries may include a composite anode that includes an aluminum anode core coated with a selectively reactive coating of zinc alloy. Such a composite anode may be stored together with an electrolyte, as the selectively reactive coating may not chemically react with the electrolyte during storage of the aluminum air battery. In operation, the selectively reactive coating may be capable of chemically reacting with the electrolyte during discharge of the aluminum air battery. Accordingly, the selectively reactive coating may be removed from the aluminum anode core during discharge of the aluminum air battery.

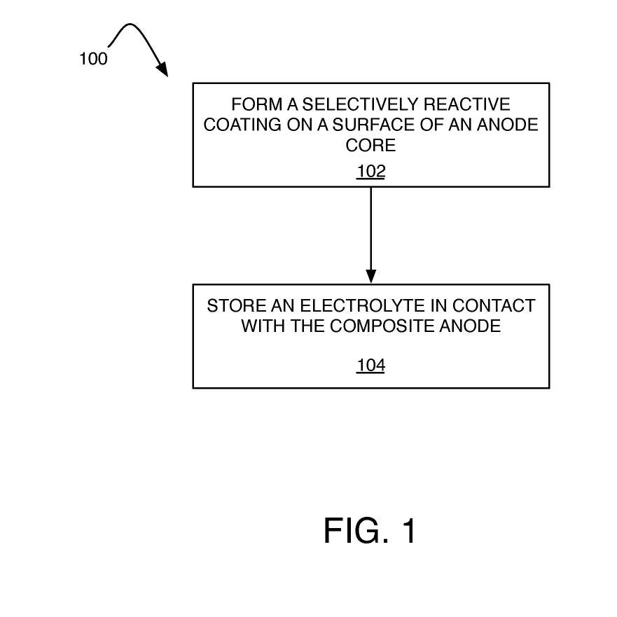

FIG. 1 is an illustration of an example process 100 to produce an aluminum air battery that is arranged in accordance with at least some embodiments of the present disclosure. In the illustrated example, process 100, and other processes described herein, set forth various functional blocks or actions that may be described as processing steps, functional operations, events and/or acts, etc. Those skilled in the art in light of the present disclosure will recognize that numerous alternatives to the functional blocks shown in FIG. 1 may be practiced in various implementations. For example, although process 100, as shown in FIG. 1, comprises one particular order of blocks or actions, the order in which these blocks or actions are presented does not necessarily limit claimed subject matter to any particular order. Likewise, intervening actions not shown in FIG. 1 and/or additional actions not shown in FIG. 1 may be employed and/or some of the actions shown in FIG. 1 may be eliminated, without departing from the scope of claimed subject matter. Process 100 may include one or more of operations as illustrated by blocks 102 and/or 104.

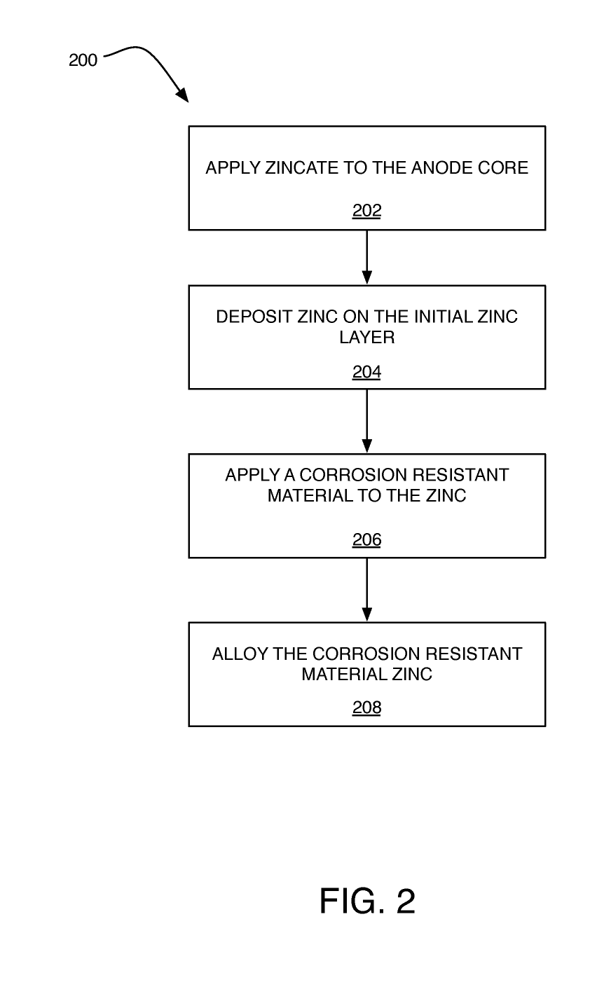

As illustrated, process 100 may be implemented to produce an aluminum air battery. Processing may begin at operation 102, “form a selectively reactive coating on a surface of an anode core”, where a selectively reactive coating may be formed on a surface of an anode core to form a composite anode. For example, the selectively reactive coating may include a zinc alloy, and the anode core may include aluminum. Zinc and/or zinc alloy may have an increased corrosion resistance in alkaline electrolytes (as compared with aluminum) since zinc is more noble than aluminum. However, pure zinc may corrode in the presence of alkaline electrolytes. In one example, the zinc alloy of the selectively reactive coating may include a corrosion resistant material, wherein the corrosion resistant material may include one or more of the following substances: indium, gallium, lead, thallium, and mercury. Additional details regarding example implementations of forming a selectively reactive coating on a surface of an anode core may be found below in the discussion of FIG. 2. A used herein the term “selectively reactive coating” may refer to a coating that is non-reactive (or less-reactive as compared with the anode core) with respect to an electrolyte stored in contact with the composite anode in a metal air battery. In one example, during storage of the aluminum air battery, the selectively reactive coating associated with the composite anode may not chemically react with the electrolyte (i.e., the selectively reactive coating may be minimally reactive with respect to an electrolyte so as to not detrimentally impact the composite anode).

Processing may continue from operation 102 to operation 104, “store an electrolyte in contact with the composite anode”, where an electrolyte may be stored in contact with the composite anode. For example, the electrolyte may include an alkaline electrolyte, such as potassium hydroxide, sodium hydroxide or the like. Such an electrolyte may be devoid of additives (or have reduced levels of additives) that might be typically utilized to inhibit corrosion of aluminum. Such additives may typically enter to electrolyte from the anode to help protect the aluminum from corrosion, and may include substances such as such as tin, indium, thallium, iridium or gallium, for example.

In one example, during storage of the aluminum air battery, the selectively reactive coating associated with the composite anode may not chemically react with the electrolyte. Conversely, during discharge of the aluminum air battery, the selectively reactive coating may be capable of chemically reacting with the electrolyte. Accordingly, in operation, the selectively reactive coating may be removed from the aluminum anode core during discharge of the aluminum air battery.

FIG. 2 illustrates another example to produce an aluminum air battery that is arranged in accordance with at least some embodiments of the present disclosure. Process 200 may include one or more of operations as illustrated by blocks 202, 204, 206, and/or 208.

As illustrated, process 200 may provide one or more examples of implementations of process 100 of FIG. 1. As illustrated, process 200 may be implemented to produce an aluminum air battery. Processing may begin at operation 202, “apply zincate to the anode core”, where zincate may be applied to the anode core to form an initial zinc layer. For example, zincate may be applied to the anode core via immersion to form the initial zinc layer.

Processing may continue from operation 202 to operation 204, “deposit zinc on the initial zinc layer”, where zinc may be deposited on the initial zinc layer. For example, zinc may be deposited on the initial zinc layer via an electrochemical zinc plating bath.

Processing may continue from operation 204 to operation 206, “apply a corrosion resistant material to the zinc”, where a corrosion resistant material may be applied to the zinc. For example, such a corrosion resistant material may be applied to the zinc via immersion. In one example, the corrosion resistant material may include one or more of the following substances: indium, gallium, lead, thallium, and mercury.

Processing may continue from operation 206 to operation 208, “alloy the corrosion resistant material and zinc”, where the corrosion resistant material and zinc may be alloyed to form the selectively reactive coating. For example, the corrosion resistant material and zinc may be alloyed to form the selectively reactive coating via heat treatment. In one example, the corrosion resistant material and zinc may be alloyed at a temperature level of from about 125° C. to about 150° C. (i.e., at about 125° C.) for a time period of from about ten minutes to about twenty minutes (i.e., for about fifteen minutes). Such temperature levels and/or time periods may be selected to alloy the corrosion resistant material and zinc without diffusing zinc into the aluminum.

The selectively reactive coating may be formed to have a ratio of corrosion resistant material to zinc from one hundred parts per million to one thousand parts per million (i.e. approximately five hundred parts per million). In one example, the corrosion resistant material may be capable of enhancing the ability of the zinc to not chemically react with the electrolyte during storage of the aluminum air battery.

Those skilled in the art in light of the present disclosure will recognize that numerous alternatives to the functional blocks shown in FIG. 2 may be practiced in various implementations. For example, although process 200, as shown in FIG. 2, comprises one particular order of blocks or actions, selectively reactive coating 310 may be applied to any shape of anode core 302 using any number of combinations of immersion, electroless plating, electroplating, and/or other deposition processes.

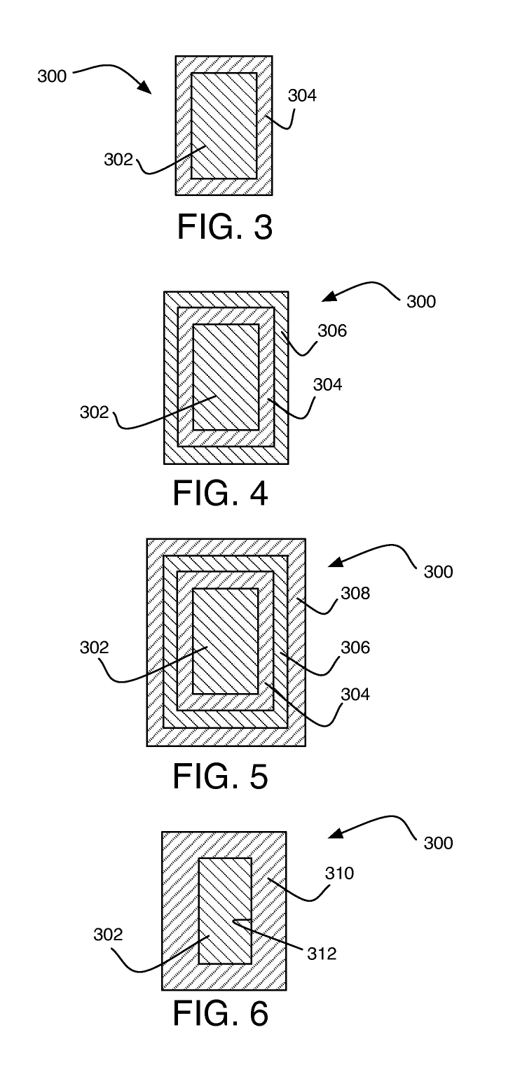

FIGS. 3-6 illustrate example structures for fabricating a composite anode 300 for use in aluminum air batteries. FIGS. 3-6 are provided for purposes of illustration and are not intended to depict structures having exact dimensionalities, shapes etc. nor to depict all components or structures that may be present in some implementations but that have been excluded from FIGS. 3-6 to avoid unnecessarily obscuring claimed subject matter.

FIG. 3 is an illustration of an example cross-sectional side view of a portion of a composite anode 300 at a given stage of processing, in accordance with at least some embodiments of the present disclosure. As illustrated, composite anode 300 may include an anode core 302. Anode core 302 may be of any shape, such as a rectangular-type plate form, a wedged-type plate form, or the like, for example. Other shapes may be used, such as pellets for a mechanically rechargeable battery, for example. Anode core 302 may include aluminum. Anode core 302 may include aluminum without being alloyed with additives such as tin and/or other metals, for example. Additives, such as tin, may increase the internal resistance of a battery by causing the electrolyte to gel during use, and/or may make recycling of the battery more complex.

An initial zinc layer 304 may be applied to anode core 302. For example, initial zinc layer 304 may be applied to anode core 302 via immersion in Zincate or other suitable technique immersion (i.e., one or more monolayers of initial zinc layer 304 may be applied via immersion). Initial zinc layer 304 may be utilized as relatively thin adherent layer for applying additional zinc layer(s).

FIG. 4 is an illustration of an example cross-sectional side view of a portion of a composite anode 300 at a given stage of processing, in accordance with at least some embodiments of the present disclosure. As illustrated, one or more additional zinc layers 306 may be deposited on composite anode 300. For example, additional zinc layer 306 may be deposited on the initial zinc layer 304 via an electrochemical zinc plating bath or other suitable technique. Additional zinc layer 306 may have a thickness from about 0.20 μm to about 0.50 μm, or more particularly, may have a thickness from about 0.20 μm to about 0.25 μm (i.e., about 0.25 μm).

FIG. 5 is an illustration of an example cross-sectional side view of a portion of a composite anode 300 at a given stage of processing, in accordance with at least some embodiments of the present disclosure. As illustrated, a corrosion resistant material 308 may be applied to composite anode 300. For example, corrosion resistant material 308 may be applied to additional zinc layer 306 via immersion (i.e., one monolayer, two monolayers, or more monolayers of corrosion resistant material 308 may be applied via immersion). In one example, corrosion resistant material 308 may include one or more of the following substances: indium, gallium, lead, thallium, and mercury.

FIG. 6 is an illustration of an example cross-sectional side view of a portion of a composite anode 300 at a given stage of processing, in accordance with at least some embodiments of the present disclosure. As illustrated, a selectively reactive coating 310 may be formed on a surface 312 of anode core 302. For example, corrosion resistant material 308 (see FIG. 5) may be alloyed with additional zinc layer 306 (see FIG. 5) (potentially including initial zinc layer 304) to form selectively reactive coating 310 via heat treatment. Temperature levels and/or time periods associated with such a heat treatment may be selected to alloy corrosion resistant material 308 (see FIG. 5) with additional zinc layer 306 (see FIG. 5) without diffusing zinc into anode core 302.

Selectively reactive coating 310 may be formed to have a ratio of corrosion resistant material to zinc from one hundred parts per million to one thousand parts per million (i.e. approximately five hundred parts per million). In one example, such corrosion resistant material may be capable of enhancing the ability of the zinc to not chemically react with the electrolyte during storage of the aluminum air battery. Further, selectively reactive coating 310 may be formed to have a volume of about 0.001% to about 0.01% of the volume of the anode core 302. Accordingly, the overall amounts of corrosion resistant material 308 (see FIG. 5), which may include one or more heavy metals, in an aluminum air battery may be in a sub-parts per million level.

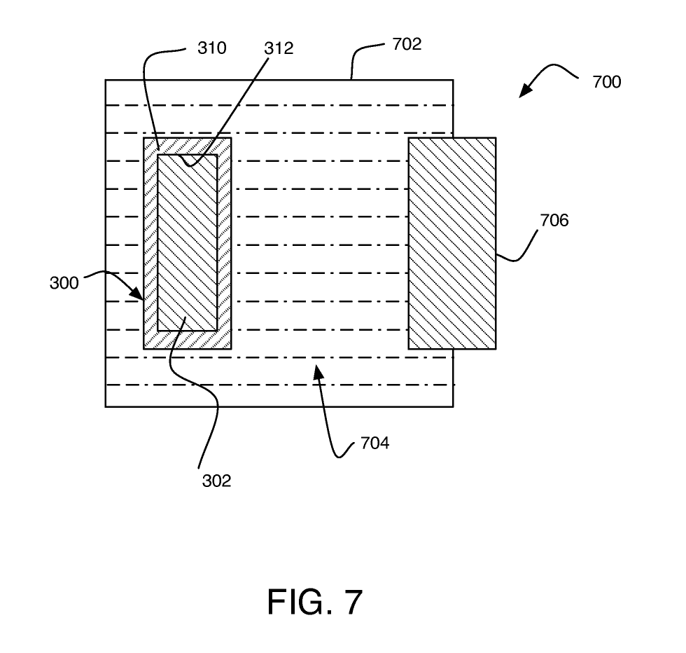

FIG. 7 is an illustration of an example aluminum air battery 700, in accordance with at least some embodiments of the present disclosure. As illustrated, aluminum air battery 700 may include composite anode 300. As described above, composite anode 300 may include selectively reactive coating 310 coupled to surface 312 of anode core 302. Selectively reactive coating 310 may include a zinc alloy, and anode core 302 may include aluminum.

A battery housing 702 may contain composite anode 300. An electrolyte 704 may be stored in battery housing 702 so as to be in contact with composite anode 300. An air cathode 706 may be stored in battery housing 702 so as to be in contact with electrolyte 704. For example, cathode 706 may include a metallic screen coated or impregnated with a catalyst such as silver, platinum, platinum-ruthenium, spinel, perovskites, iron, nickel, or the like.

Selectively reactive coating 310 may not chemically react with electrolyte 704 during storage of aluminum air battery 700. In operation, selectively reactive coating 310 may be capable of chemically reacting with electrolyte 704 during discharging of aluminum air battery 700. Accordingly, selectively reactive coating 310 may protect aluminum anode core 302 during storage and may be removed from aluminum anode core 302 during discharge of aluminum air battery 700. Accordingly, aluminum air battery 700 may not include a storage tank capable of storing electrolyte 704 separate from composite anode 300. Similarly, aluminum air battery 700 may not include a pump system capable of controlling the flow of electrolyte 704 to composite anode 300.

For example, the primary fuel for aluminum air battery 700 may be the aluminum associated with anode core 302. Selectively reactive coating 310 may operate as a secondary fuel of a more noble metal (i.e., a zinc and/or a zinc alloy). Selectively reactive coating 310 may be more resistant to corrosion than the aluminum associated with anode core 302, and may protect the aluminum associated with anode core 302 from corrosion during storage. When a load is first applied, selectively reactive coating 310 may be consumed as fuel, revealing the more reactive aluminum associated with anode core 302.

As selectively reactive coating 310 is consumed, aluminum air battery 700 may have the characteristics of a zinc air cell. For example, a nominal zinc cell voltage may operate at about 1.65 volts (V), but may typically operate between 1.35 V and 1.40 V. The zinc and/or zinc alloy may enter electrolyte 704 as zincate (i.e., (Zn(OH)₄²⁻) and may precipitate out as zinc oxide (ZnO) solid to regenerate electrolyte 704. When the zinc and/or zinc alloy is fully depleted, the aluminum associated with anode core 302 may be exposed and aluminum air battery 700 behaves as an aluminum air cell. For example, an aluminum air cell may operate at about 1.2 V, differing somewhat from the characteristics of a zinc air cell. Although the amount of current delivered as selectively reactive coating 310 is consumed will be relatively small due to the size of selectively reactive coating 310, a device using aluminum air battery 700 may be insensitive to such a voltage difference.

The resulting aluminum air battery 700 may have a variety of shapes. For example, battery 700 may be oriented and arranged so as to be suitable for various products such as portable electronics (i.e., cell phones, portable computers, cameras, personal digital assistants, etc.), hearing aids, emergency back-up systems, mobile soldier applications, military applications, aerospace applications, and/or the like. After an initial use, aluminum air battery 700 may not be stored for extended periods of time without corrosion occurring at anode core 302. However, this may not be an issue for products such as portable electronics (i.e., cell phones, portable computers, cameras, personal digital assistants, etc.), hearing aids, emergency back-up systems, mobile soldier applications, military applications, aerospace applications, and/or the like.

Other components of battery 700 are contemplated, but not illustrated here. For example, battery 700 may include air access apertures in housing 702, an anode can adapted to house composite anode 300 within housing 702, a separator fabric saturated with electrolyte, a cathode can adapted to house cathode 706 within housing 702, a hydrophobic layer adapted to prevent moisture from entering battery 700 and flooding cathode 706, one or more air distribution membranes and/or air diffusion layers, and/or the like. Those skilled in the art in light of the present disclosure will recognize that numerous alternative components may be utilized in various implementations. For example, some of the components listed above may be eliminated or replaced with alternative components. Likewise, additional components not explicitly listed above may be employed, without departing from the scope of claimed subject matter.

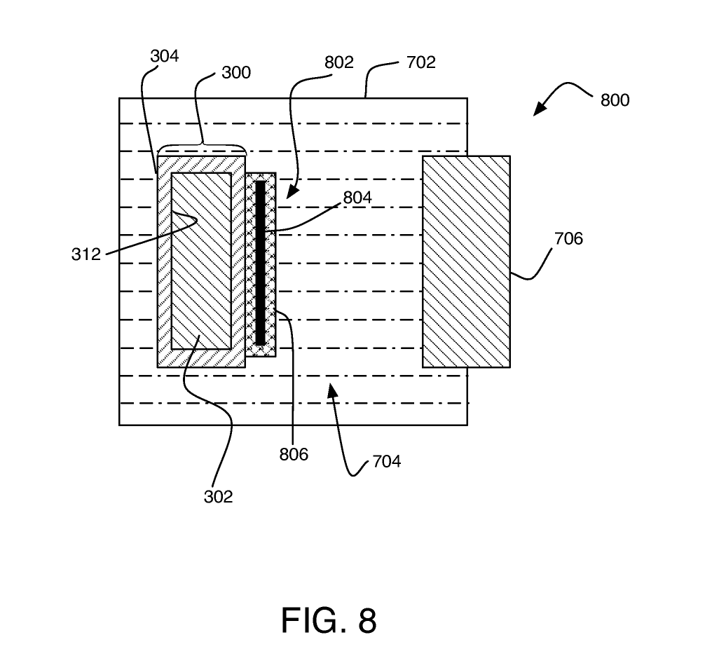

FIG. 8 is an illustration of another aluminum air battery 800, in accordance with at least some embodiments of the present disclosure. As illustrated, aluminum air battery 800 may include composite anode 300. In this example, composite anode 300 may include a zinc coating, such as initial zinc coating 304 coupled to surface 312 of anode core 302. For example, composite anode 300 may not include corrosion resistant material 308 (see FIG. 5), additional zinc layer 306 (see FIG. 5), and/or selectively reactive coating 310 (see FIG. 6). Anode core 302 may include aluminum.

As discussed above, battery housing 702 may contain composite anode 300. Electrolyte 704 may be stored in battery housing 702 so as to be in contact with composite anode 300. Air cathode 706 may be stored in battery housing 702 so as to be in contact with electrolyte 704.

An anode corrosion inhibitor 802 may be electrically connected to composite anode 300. Anode corrosion inhibitor 802 may include an inert substrate core 804 that may be electrically connected to composite anode 300. For example, inert substrate core 804 may have a positive standard electric potential greater than zinc. Examples of substances that may be utilized for inert substrate core 804 may include one or more of the following substances: copper, gold, palladium, platinum, cobalt, and nickel. In one example, copper has a standard electric potential of +0.34 volts (V), while zinc has a standard electric potential of −0.76V.

Anode corrosion inhibitor 802 may include an anode corrosion inhibitor material 806 that may be coupled to inert substrate core 804 and positioned adjacent to (or in contact with) composite anode 300. Examples of substances that may be utilized for an anode corrosion inhibitor material 806 may include one or more of the following substances: indium, gallium, lead, thallium, and mercury. In one example, a copper-type inert substrate core 804 may be electroplated with an indium-type anode corrosion inhibitor material 806. For example, anode corrosion inhibitor 802 may include a copper wire or wire mesh coated with from about 0.025 μm to about 0.127 μm of indium. In other examples, anode corrosion inhibitor material 806 may be applied using any number of combinations of immersion, electroless plating, electroplating, and/or other deposition processes.

As illustrated, anode corrosion inhibitor 802 may be formed as one or more wires. Additionally or alternatively, anode corrosion inhibitor 802 may be formed as one or more wire meshes, anode cups, current collectors, the like, or combinations thereof. As used herein the term “anode cup” may refer to a conductive structure that may be capable of partially housing the composite anode (i.e., a cup portion of a battery housing in button-type batteries). As used herein the term “current collector” may refer to a conductive structure that may be capable of collecting electrons on the anode side of a battery and also may allow for electrolyte fluid flow therethrough (i.e., microporous).

In operation, anode corrosion inhibitor 802 may inhibit a chemical reaction between composite anode 300 and electrolyte 704 during storage of aluminum air battery 800. For example, the presence of anode corrosion inhibitor material 806 positioned adjacent to (or in contact with) initial zinc coating 304 may operate to inhibit a chemical reaction between initial zinc coating 304 and electrolyte 704 during storage of aluminum air battery 800. Accordingly, zinc coating 304 in conjunction with anode corrosion inhibitor 802 may protect aluminum anode core 302 during storage, while zinc coating 304 may be removed from aluminum anode core 302 during discharge of aluminum air battery 700. Accordingly, aluminum air battery 800 may not include a storage tank capable of storing electrolyte 704 separate from composite anode 300. Similarly, aluminum air battery 800 may not include a pump system capable of controlling the flow of electrolyte 704 to composite anode 300.

The resulting aluminum air battery 800 may have a variety of shapes. For example, battery 800 may be oriented and arranged so as to be suitable for various products such as portable electronics (i.e., cell phones, portable computers, cameras, personal digital assistants, etc.), hearing aids, emergency back-up systems, mobile soldier applications, military applications, aerospace applications, and/or the like. After an initial use, aluminum air battery 800 may not be stored for extended periods of time without corrosion occurring at anode core 302. However, this may not be an issue for products such as portable electronics (i.e., cell phones, portable computers, cameras, personal digital assistants, etc.), hearing aids, emergency back-up systems, mobile soldier applications, military applications, aerospace applications, and/or the like.

Other components of battery 800 are contemplated, but not illustrated here. For example, battery 800 may include air access apertures in housing 702, an anode can adapted to house composite anode 300 within housing 702, a separator fabric saturated with electrolyte, a cathode can adapted to house cathode 706 within housing 702, a hydrophobic layer adapted to prevent moisture from entering battery 800 and flooding cathode 706, one or more air distribution membranes and/or air diffusion layers, and/or the like. Those skilled in the art in light of the present disclosure will recognize that numerous alternative components may be utilized in various implementations. For example, some of the components listed above may be eliminated or replaced with alternative components. Likewise, additional components not explicitly listed above may be employed, without departing from the scope of claimed subject matter.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method to produce an aluminum air battery, comprising:
forming a selectively reactive coating on a surface of an anode core to form a composite anode, the selectively reactive coating comprising a zinc alloy and the anode core comprising aluminum; and
storing an electrolyte in contact with the composite anode, wherein the selectively reactive coating is capable of chemically reacting with the electrolyte during discharging of the aluminum air battery.

2. The method of claim 1, wherein forming comprises forming a selectively reactive coating comprising at least one or more of indium, gallium, lead, thallium, or mercury.

3. The method of claim 1, wherein the forming of the selectively reactive coating comprises alloying a corrosion resistant material and zinc together to form the selectively reactive coating via heat treatment, wherein the corrosion resistant material comprises one or more of indium, gallium, lead, thallium, or mercury.

4. The method of claim 1, wherein the forming of the selectively reactive coating comprises alloying a corrosion resistant material and zinc together to form the selectively reactive coating via heat treatment, wherein the corrosion resistant material comprises one or more of indium, gallium, lead, thallium, or mercury, and wherein the selectively reactive coating comprises a ratio of corrosion resistant material to zinc from one hundred parts per million to one thousand parts per million.

5. The method of claim 1, wherein the forming of the selectively reactive coating comprises:
applying zincate to the anode core to form an initial zinc layer;
depositing zinc on the initial zinc layer;
applying a corrosion resistant material to the zinc, wherein the corrosion resistant material is capable of enhancing the ability of the selectively reactive coating to not chemically react with the electrolyte during storage of the aluminum air battery; and
alloying the corrosion resistant material and zinc to form the selectively reactive coating.

6. The method of claim 1, wherein the forming of the selectively reactive coating comprises:
applying zincate to the anode core via immersion to form an initial zinc layer;
depositing zinc on the initial zinc layer via an electrochemical zinc plating bath;
applying a corrosion resistant material to the zinc via immersion; and
alloying the corrosion resistant material and zinc to form the selectively reactive coating via heat treatment, wherein the corrosion resistant material is capable of enhancing the ability of the zinc to not chemically react with the electrolyte during storage of the aluminum air battery, wherein the corrosion resistant material comprises one or more of indium, gallium, lead, thallium, or mercury, and wherein the selectively reactive coating comprises a ratio of corrosion resistant material to zinc from one hundred parts per million to one thousand parts per million.

7. The method of claim 1, wherein the electrolyte comprises an alkaline electrolyte.

8. An aluminum air battery, comprising:
a composite anode, wherein the composite anode comprises:
an anode core, wherein the anode core comprises aluminum,
a selectively reactive coating coupled to the surface of the anode core, wherein the selectively reactive coating comprises a zinc alloy;
a battery housing, the battery housing containing the composite anode; and
an electrolyte stored in the battery housing in contact with the composite anode, wherein the selectively reactive coating is capable of chemically reacting with the electrolyte during discharging of the aluminum air battery

9. The aluminum air battery of claim 8, wherein the zinc alloy of the selectively reactive coating comprises a corrosion resistant material, wherein the corrosion resistant material comprises one or more of indium, gallium, lead, thallium, or mercury, and wherein the selectively reactive coating comprises a ratio of corrosion resistant material to zinc from one hundred parts per million to one thousand parts per million.

10. The aluminum air battery of claim 8, wherein the electrolyte comprises potassium hydroxide and/or sodium hydroxide.

11. The aluminum air battery of claim 8, wherein the aluminum air battery does not include a storage tank capable of storing the electrolyte separate from the composite anode.

12. The aluminum air battery of claim 8, wherein the aluminum air battery does not include a pump system capable of controlling the flow of the electrolyte to the composite anode.

13. An aluminum air battery, comprising:
a composite anode, wherein the composite anode comprises:
an anode core, wherein the anode core comprises aluminum,
a zinc coating coupled to the surface of the anode core;
an anode corrosion inhibitor electrically connected to the composite anode, wherein the anode corrosion inhibitor comprises:
an inert substrate core, wherein the inert substrate core is electrically connected to the composite anode,
an anode corrosion inhibitor material coupled to the inert substrate core, wherein the anode corrosion inhibitor material comprises one or more of indium, gallium, lead, thallium, or mercury; and
a battery housing, the battery housing containing the composite anode; and
an electrolyte stored in the battery housing in contact with the composite anode, wherein the anode corrosion inhibitor inhibits a chemical reaction between the composite anode and the electrolyte during storage of the aluminum air battery.

14. The aluminum air battery of claim 13, wherein the inert substrate core has a positive standard electric potential greater than zinc.

15. The aluminum air battery of claim 13, wherein inert substrate core comprises one or more of copper, gold, palladium, platinum, cobalt, or nickel.

16. The aluminum air battery of claim 13, wherein the electrolyte comprises potassium hydroxide and/or sodium hydroxide.

17. The aluminum air battery of claim 13, wherein the aluminum air battery does not include a storage tank capable of storing the electrolyte separate from the composite anode.

18. The aluminum air battery of claim 13, wherein the aluminum air battery does not include a pump system capable of controlling the flow of the electrolyte to the composite anode.

19. A composite anode, comprising:
an anode core, wherein the anode core comprises aluminum; and
a selectively reactive coating coupled to the surface of the anode core, wherein the selectively reactive coating comprises a zinc alloy,
wherein the zinc alloy of the selectively reactive coating comprises a corrosion resistant material, wherein the corrosion resistant material comprises one or more of indium, gallium, lead, thallium, or mercury.

20. The composite anode of claim 19, wherein the selectively reactive coating comprises a ratio of corrosion resistant material to zinc from one hundred parts per million to one thousand parts per million.
